(19) United States
(12) Patent Application Publication
(10) Pub. No.: US 2008/0186732 A1
(43) Pub. Date: Aug. 7, 2008

(54) LIGHT EMITTING DIODE MODULES FOR ILLUMINATED PANELS

(76) Inventors: George K. Awai, Danville, CA (US); Michael D. Ernst, Alamo, CA (US); Alain S. Corcos, Northridge, CA (US)

Correspondence Address: KANG LIM, 3494 CAMINO TASSAJARA ROAD #436, DANVILLE, CA, 94506, US

(21) Appl. No.: 11/670,981

(22) Filed: Feb. 3, 2007

(51) Int. Cl. F21V 7/04

(52) U.S. Cl. 362/609

(57) ABSTRACT

LED modules are provided for efficiently illuminating edge illuminated panels. Each LED module includes a base, an LED located substantially within the base, an inner beam director, and an outer beam director. An interface between the inner beam director and the outer beam director is shaped to refract and/or reflect the light beam along the interface, thereby narrowing a substantial portion of the light beam generated by the LED. For light output efficiency, each LED can have a geometrically coated phosphor layer which produces a whiter light beam. The interface between the inner and outer beam directors can be curved and/or substantially flat. The N value of the inner beam director is generally lower than the N value of the outer beam director thereby enabling the LED module to generate a substantially narrow beam of light. In some embodiments, the interface between the inner beam director and the outer beam director includes an intermediate beam director configured to further refract and/or reflect the light beam generated by the LED.

### CROSS REFERENCE TO RELATED APPLICATIONS

This application is related to co-pending and concurrently filed application Ser. No. ______, (Attorney Docket Number IM 0603) filed Feb. 3, 2007, entitled “Edge-Illuminated Panels With Shaped-Edge Diffuser”, by George K. Awai, Michael D. Ernst and Alain S. Corcos, which is incorporated by reference herein for all purposes.

### BACKGROUND OF THE INVENTION

This invention relates generally to illuminating panels. More particularly, this invention relates to light emitting diode (LED) modules for edge illuminated panels.

Illuminated panels have many uses where evenly lit panels with neutral color temperature are used including advertising display panels, shopping mall directories, restaurant menus, event schedules, and navigational signboards. Other uses for illuminated panels include light-boxes for artists, photographers, architects, design engineers, general contractors and draftsmen.

These illuminated panels can be as small as six inches by six inches, and as large as four feet by eight to ten feet or larger. Most illuminated panels are edged lighted so as to minimize the thickness of the panels and also for cost and manufacturability reasons. In addition, the compact size and durability of LEDs are suitable for compact edge lighting for illuminating display panels.

However, as the panel size increases, the edge lighting has to travel further into the panel and hence the perceived light intensity near the center of the panel tends to appear substantially dimmer then that near the edge of the panel. Since, most casual observers are able to perceive differences in light intensity substantially greater than 20%, this unevenness in light intensity is particularly acute with large panels commonly used for advertising.

Because of their inherent electrical properties, efficient LEDs start out as blue or blue-violet light emitters. In order to produce white light, a phosphor layer is placed on top of the LED. The result is a wide-angled beam pattern usually 120%. Such wide-angled LEDs are suitable for area lighting. If a more focused beam is needed, e.g., for a flashlight, an external convex lens is added to the package. Unfortunately, the resulting package is now larger, and other problems may also result such as lens adhesion and Fresnel losses associated with the additional lens and adhesive.

It is therefore apparent that an urgent need exists for a compact LED module suitable for evenly and efficiently illuminating large edge lighted panels, and is easy to manufacturer, easy to maintain, shock resistant, impact resistant, portable, cost effective, and have long lamp-life.

### SUMMARY OF THE INVENTION

To achieve the foregoing and in accordance with the present invention, light emitting diode (LED) modules for illuminating panels such as advertising display panels are provided. Such LED modules can be operated very efficiently, cost-effectively and with minimal maintenance once installed in the field.

In accordance with one embodiment of the invention, LED modules are configured to edge illuminate panels. Each LED module includes a base, an LED located substantially within the base, an inner beam director, and an outer beam director. An interface between the inner beam director and the outer beam director is shaped to refract and/or reflect the light beam along the interface, thereby narrowing a substantial portion of the light beam generated by the LED. For light output efficiency, each LED can have a geometrically coated phosphor layer to produce a whiter light beam.

The interface between the inner and outer beam directors can be curved or substantially flat. For example, interface can be parabolic, elliptical or cone-shaped. The N value of the inner beam director is lower than the N value of the outer beam director thereby enabling the LED module to generate a substantially narrow beam of light.

In some embodiments, the interface between the inner beam director and the outer beam director includes an intermediate beam director configured to further refract and reflect the light beam generated by the LED. The N value of the intermediate beam director is higher than the N value of the inner beam director, but lower than the N value of the outer beam director.

These and other features of the present invention will be described in more detail below in the detailed description of the invention and in conjunction with the following figures.

### BRIEF DESCRIPTION OF THE DRAWINGS

In order that the present invention may be more clearly ascertained, one embodiment will now be described, by way of example, with reference to the accompanying drawings, in which:

FIG. 1A is a front view of one embodiment of the present invention;

FIG. 1B is a cross-sectional view 1B-1B of FIG. 1A;

FIG. 1C is a cross-sectional view of a variant of the embodiment of FIG. 1;

FIG. 2 is a front view of another variant of the embodiment of FIG. 1;

FIG. 3 is a front view of yet another variant of the embodiment of FIG. 1;

FIG. 4A is a front view of another embodiment of the invention;

FIG. 4B is a cross-sectional view 4B-4B of FIG. 4A;

FIG. 5A is a front view of yet another embodiment of the invention;

FIG. 5B is a cross-sectional view 5B-5B of FIG. 5A;

FIGS. 6A and 6B are cross-sectional views illustrating another variant of an illuminated display for the embodiments of FIGS. 4A and 5A;

FIGS. 7A, 7B and 7C are an isometric view, a cut-away view and a cross-sectional view, respectively, of an LED module 700 in accordance with an aspect of the present invention;

FIGS. 7D, 7E are cross-sectional views of a substantially reflective module and a refractive/reflective module in accordance with the present invention;

FIGS. 8A-10E are cross-sectional views of additional embodiments of the LED modules of the present invention;

FIG. 11 illustrates how the LED modules of the present invention can be used to illuminate display panels;

FIG. 12A-13B are cross-sectional views showing edge profiles of display panels in accordance with another aspect of the invention; and

FIG. 14 is a cutaway front view showing two rows of LED modules for illuminating a display panel in accordance with the invention.

### DETAILED DESCRIPTION OF THE INVENTION

The present invention will now be described in detail with reference to several embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

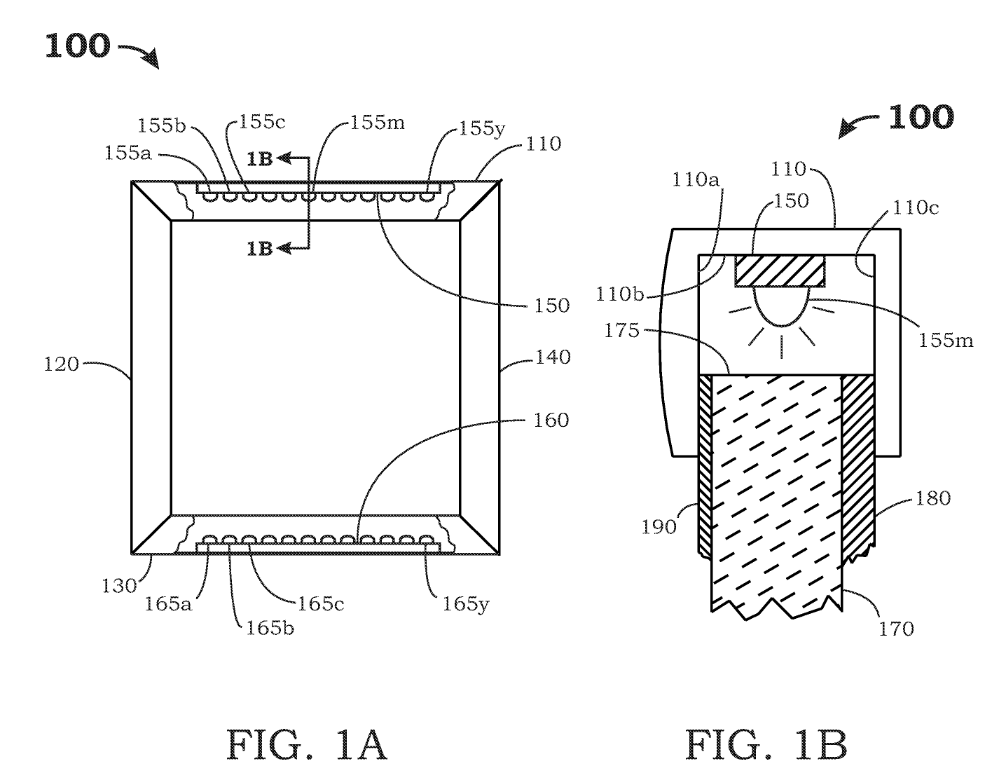

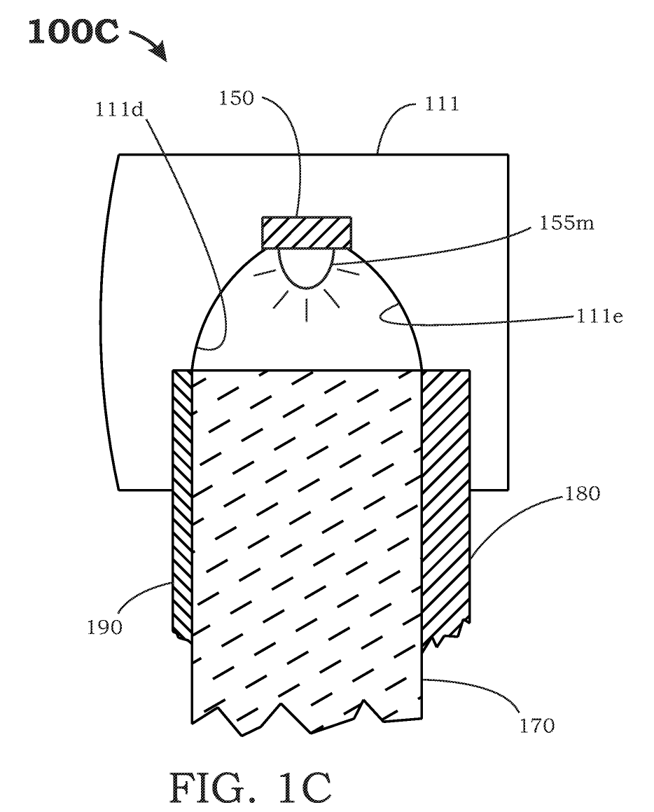

FIG. 1A is a front view showing one embodiment of an illuminated panel 100 in accordance with the present invention. Panel 100 includes frame members 110, 120, 130, 140. To facilitate discussion, the front portion of top frame member 110 and the front portion of bottom frame member 130 have cutaways exposing a top row of point light sources 155a, 155b, 155c . . . 155y and a bottom row of point light sources 165a, 165b, 165c . . . 165y, respectively.

The top row of point light sources 155a, 155b, 155c . . . 155y are mounted a light base 150 which functions as a mounting support and also as means for providing power and control to light sources 155a, 155b, 155c . . . 155y. Similarly, the bottom row of point light sources 165a, 165b, 165c . . . 165y are mounted a light base 160 which functions as a mounting support and also as means for providing power and control to light sources 165a, 165b, 165c . . . 165y. Depending on the overall panel dimensions and cost, weight, and/or power constraints of panel 100, one member, two members (as shown in this example), three members or all four members of frame members 110, 120, 130, 140 can be illuminated. In addition, power and control circuitry for panel 100 can either be internal, external, or combinations thereof, with respect to frame members 110, 120, 130, 140.

In this embodiment, point light sources 155a, 155b, 155c . . . 155y and 165a, 165b, 165c . . . 165y can be low-wattage light emitting diodes (LEDs) commercially available from www.nichia.com, www.cree.com or www.lumileds.com. LEDs 155a, 155b, 155c . . . 155y and 165a, 165b, 165c . . . 165y are spaced about one-quarter of an inch apart from each other, resulting in about forty-eight LEDs per linear foot of light bases 150, 160, respectively. Each LED consumes about 20 mA and emits about 5 candela of visible light. LEDs 155a, 155b, 155c . . . 155y and 165a, 165b, 165c . . . 165y can be powered and controlled using commercially available constant-current power supplies, e.g., M/W model number TSU 66A-3 which provides 12V DC@5.5A, or MWS model number 122500UC which provides 12V DC@250 mA. Another manufacturer of DC power supplies is XP Power (www.xpplc.com).

FIG. 1B is a cross-sectional view 1B-1B of panel 100 showing top frame member 110, light source 155m attached to light base 150, and an illuminated display comprising a transparency 190, a diffusion layer 170 and a back-scattering layer 180. Transparency 190 can be merely in contact with diffusion layer 170 so that transparency 190 can be easily replaced by a new or different transparency. Alternatively, transparency 190 can be permanently attached to diffusion layer 170 using a suitable adhesive or process.

Diffusion layer 170 can be made from acrylic or another suitable plastic or polymer with the required light transmitting properties available from Mitsubishi. Back-scattering layer 180 can be made from a suitable highly reflective polymer such as acrylic Styrene or vinyl, available from 3M Corporation. Back-scattering layer 180 can either in contact with diffusion layer 170, or back-scattering layer 180 can be permanently bonded to diffusion layer 170 by a suitable adhesive.

The internal reflective characteristics of the frame members of panel 100 can be enhanced by incorporating a suitable frame profile thereby increasing the effectiveness of the illumination produced by LED 155m. For example, as shown in FIG. 1C, frame member 111 has parabolic surfaces 111d, 111e to better focus the light from LED 155m into diffusion layer 170.

The internal reflective characteristics of frame member 110 and frame member 111 can be further enhanced by incorporating a suitable surface polish to inner surfaces 110a, 110b, 110c and surfaces 111d, 111e, respectively. It is also possible to apply a reflective layer in the form of coating or chemical processing including painting, electro-plating or anodizing to the inner surfaces 110a, 110b, 110c, 111d, 111e. Light base 150 can be recessed into frame member 111 to better position LED 155m relative to parabolic surfaces 111d, 111e so that more light can be reflected into diffusion layer 170.

In order to minimize the saw-tooth problem due to the increased LED spacing, surface 175 of diffusion layer 170 has a surface roughness designed to diffuse the light emitted by LEDs 155a, 155b, 155c . . . 155y as the light enters diffusion layer 170. Since diffusion layer 170 can be cut to the appropriate size using several well known techniques such as band saws and circular saws, by leaving surface 175 unpolished with saw cut marks intact or by sanding using grit #2000 or courser, ensuring that the light entering diffusion layer 170 is sufficiently diffused to mitigate the saw-tooth problem.

Other modifications to the illuminated panels of the present invention are also possible. For example, the front portion of frame member 110 can be hinged so that transparency 190 can be easily replaced and also to provide easy access to light sources 155a, 155b, 155c . . . 155y.

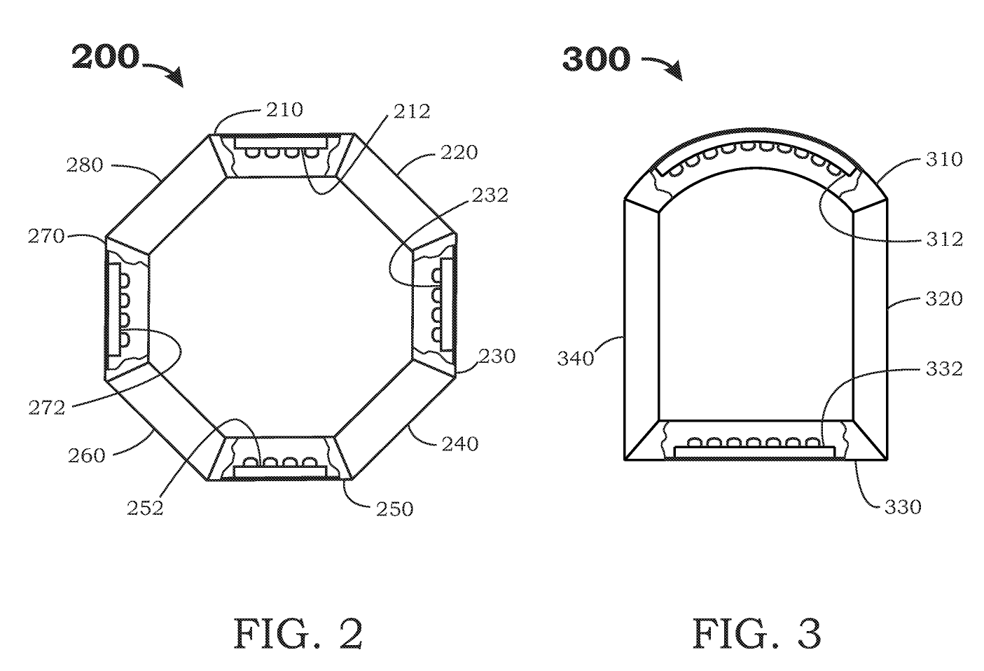

Another advantage of using point light sources is the increased variety of potential panel shapes. FIG. 2 is a cutaway front view of an octagonal panel 200 which includes frame members 210, 220, 230, 240, 250, 260, 270, 280, and light bases 212, 232, 252, 272 inside frame members 210, 230, 250, 270, respectively. Similarly, the cutaway front view of FIG. 3 illustrates a semi-circular panel 300 having a curved frame member 310 with curved light base 312, straight frame member 320, straight frame member 330 with straight light base 332, and straight frame member 340.

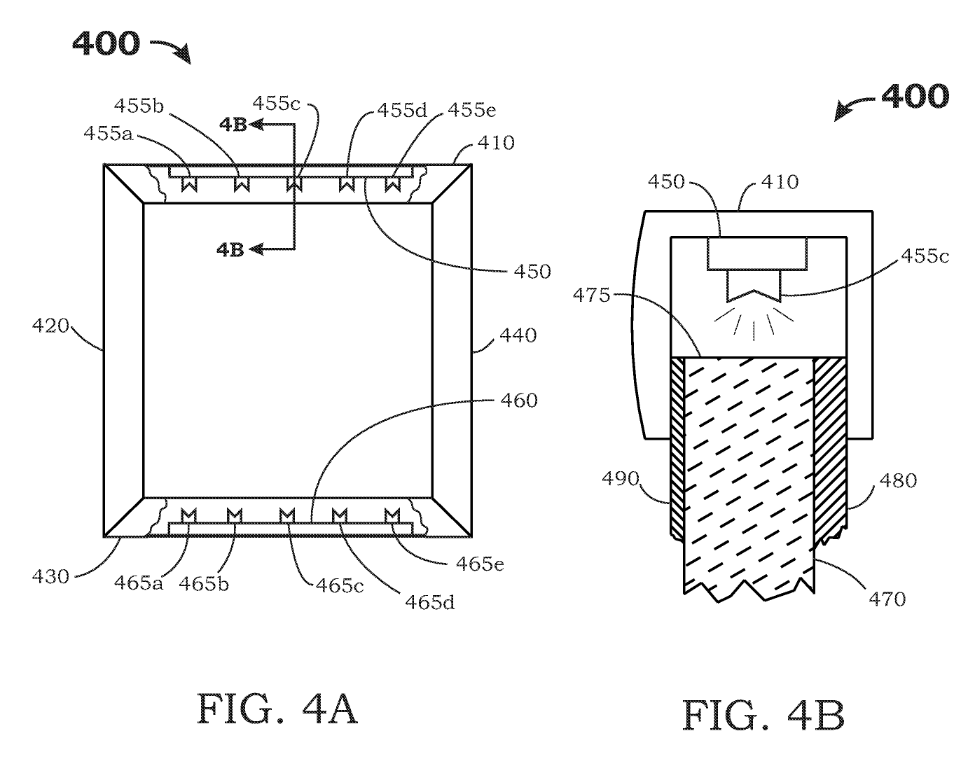

Referring now to FIG. 4A, a cutaway front view illustrating another embodiment of the present invention, illuminated panel 400 includes frame members 410, 420, 430, 440, with the front portion of top frame member 410 and the front portion of bottom frame member 430 exposed to show a top row of point light sources 455a, 455b, 455c, 455d, 455e and a bottom row of point light sources 465a, 465b, 465c, 465d, 465e, respectively. The top row of point light sources 455a, 455b, 455c, 455d, 455e are mounted on light base 450 which provides structural support and power to light sources 455a, 455b, 455c, 455d, 455e. Similarly, the bottom row of point light sources 465a, 465b, 465c, 465d, 465e are mounted on powered light base 460.

In this embodiment, point light sources 455a, 455b, 455c, 455d, 455e and 465a, 465b, 465c, 465d, 465e can be 3-Watt front-emitting Luxeon LEDs. LEDs 455a, 455b, 455c, 455d, 455e, 465a, 465b, 465c, 465d, 465e are spaced about 1 to 2 inches apart from each other, resulting in approximately 6 Luxeon LEDs per linear foot of their respective light bases 450, 460. In this example, each 3-Watt Luxeon LED emits about 60 lumens of visible light. This arrangement should be sufficient to accomplish sufficient penetration of up to two feet into diffusion layer 470 while maintaining light variation within 20% so that the variation of intensity on the surface of panel 400 is not noticeable to the average human eye.

Suitable front-emitting Luxeon LEDs are commercially available in 1-Watt, 3-Watt, 5-Watt, and other higher wattage LED modules from www.luxeon.com, for example Lumineds Lambertian LXHL PW09 white Luxeon LED. Other commercial sources of higher wattage LEDs include www.edison-opto.com.tw.

Because higher wattage Luxeon LEDs 455a, 455b, 455c, 455d, 455e, 465a, 465b, 465c, 465d, 465e generate a significant amount of heat, light bases 450, 460 also function as heat sinks for Luxeon LEDs 455a, 455b, 455c, 455d, 455e and 465a, 465b, 465c, 465d, 465e, respectively. Light bases 450, 460 in turn conduct heat to their respective frame members 410, 430.

Luxeon LEDs 455a, 455b, 455c, 455d, 455e, 465a, 465b, 465c, 465d, 465e can be powered and controlled using a constant-current power supply, such as the AED Series 36-100 Watt power supply available from www.xppower.com.

FIG. 4B is a cross-sectional view 4B-4B of panel 400 showing top frame member 410, light source 455c attached to light base 450, and an illuminated display comprising a transparency 490, a diffusion layer 470 and a back-scattering layer 480. Because brighter Luxeon LEDs 455a, 455b, 455c, 455d, 455e and 465a, 465b, 465c, 465d, 465e can be spaced further apart from each other than lower power point light sources, the saw-tooth problem associated with all point light sources is more pronounced. In accordance with one aspect of the invention, surface 475 of diffusion layer 470 has a suitable surface roughness of approximately 2000 grit and courser in order to diffuse the light emitted by LEDs 455a, 455b, 455c, 455d, 455e as the light enters diffusion layer 470. This surface roughness can be accomplished by for example by cutting with a saw having about 80-100 teeth per inch.

In addition to being reflective, the inner surfaces 410a, 410b, 410c of frame member 410 can also be made to diffusely reflect light emitted by LEDs 455a, 455b, 455c, 455d, 455e by, for example, incorporating small dimples into reflective surfaces 410a, 410b, 410c.

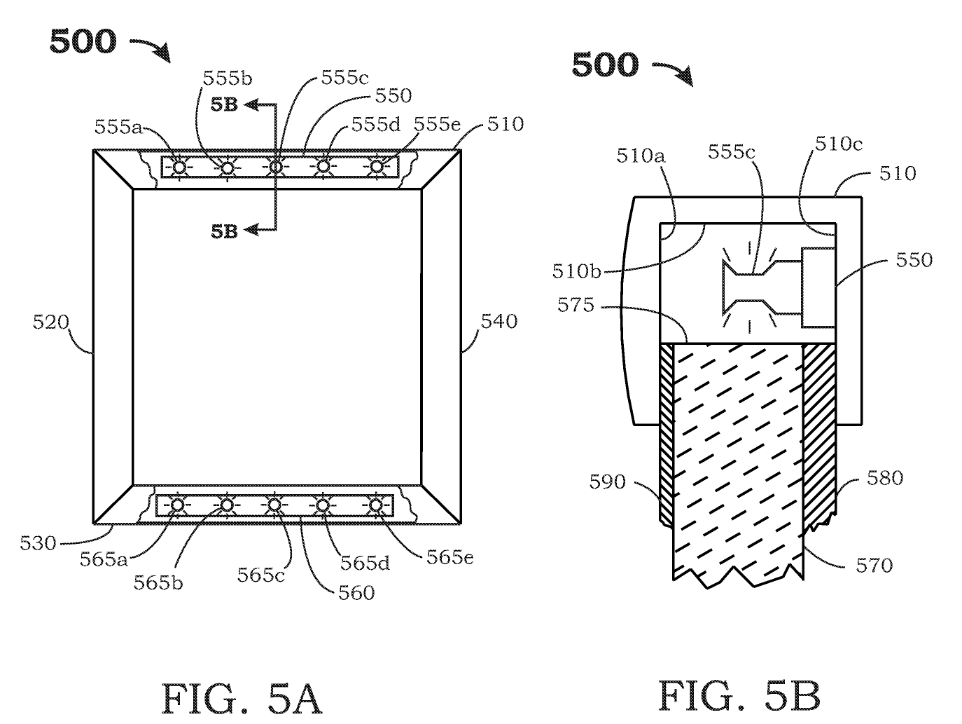

FIG. 5A is a cutaway front view showing yet another embodiment of the invention. An illuminated panel 500 includes frame members 510, 520, 530, 540, with the front portion of top frame member 510 and the front portion of bottom frame member 530 exposed to show a top row of point light sources 555a, 555b, 555c, 555d, 555e and a bottom row of point light sources 565a, 565b, 565c, 565d, 565e, respectively. The top row of point light sources 555a, 555b, 555c, 555d, 555e are mounted on light base 550 which provides structural support and power to light sources 555a, 555b, 555c, 555d, 555e. Similarly, the bottom row of point light sources 565a, 565b, 565c, 565d, 565e are mounted on powered light base 560.

Side-emitting Luxeon LEDs are commercially available in 1-Watt, 3-Watt, 5-Watt, and other higher wattage modules from www.luxeon.com. Because higher wattage Luxeon LEDs 555a, 555b, 555c, 555d, 555e, 565a, 565b, 565c, 565d, 565e generate a significant amount of heat, light bases 350, 360 also dissipate heat from LEDs 555a, 555b, 555c, 555d, 555e and 565a, 565b, 565c, 565d, 565e to frame members 510, 530, respectively. Light bases 550, 560 in turn conduct heat to their respective frame members 510, 530. Power and control circuitry for panel 500 is similar to that described above for panel 400.

FIG. 5B is a cross-sectional view 5B-5B of panel 500 showing top frame member 510, light source 555c attached to light base 550, and an illuminated display comprising a transparency 590, a diffusion layer 570 and a back-scattering layer 580. In this embodiment, point light sources 555a, 555b, 555c, 555d, 555e, 565a, 565b, 565c, 565d, 565e can be 3-Watt side-emitting Luxeon LEDs. Accordingly, LEDs 555a, 555b, 555c, 555d, 555e, 565a, 565b, 565c, 565d, 565e are oriented so the light is emitted substantially in the same plane as diffusion layer 570.

The higher wattage Luxeon LEDs 555a, 555b, 555c, 555d, 555e, 565a, 565b, 565c, 565d, 565e of panel 300 are spaced about 1 to 2 inches apart from each other, resulting in approximately 6 LEDs per linear foot of their respective light bases 550, 560. In this example, each 3-Watt Luxeon LED emits about 60 lumens of visible light. Suitable side-emitting Luxeon LEDs are commercially available from www.luxeon.com, such as the Lumileds LXHL DW09 white LED.

As discussed above, in order to minimize the saw-tooth problem due to the increased LED spacing, surface 575 of diffusion layer 570 has a suitable surface roughness designed to diffuse the light emitted by LEDs 555a, 555b, 555c, 555d, 555e as the light enters diffusion layer 570. This surface roughness can be accomplished by for example a sand-blasting medium that can penetrate surface 570a using multiple blasting heads to cause a varied density pattern thereby enabling panel 500 to output a more even light intensity.

In this embodiment, because a significant amount of light from LEDs 555a, 555b, 555c, 555d, 555e is initially emitted in a direction away from diffusion layer 570, the inner surfaces 510a, 510b, 510c of frame member 510 should be designed to efficiently and diffusely reflect light emitted by LEDs 555a, 555b, 555c, 555d, 555e toward surface 575 of diffusion layer 570. Techniques such as profiling, polishing and dimpling of reflective surface 510a, 510b, 510c described above can be employed to better utilize the higher order indirect light emitted by LEDs 555a, 555b, 555c, 555d, 555e.

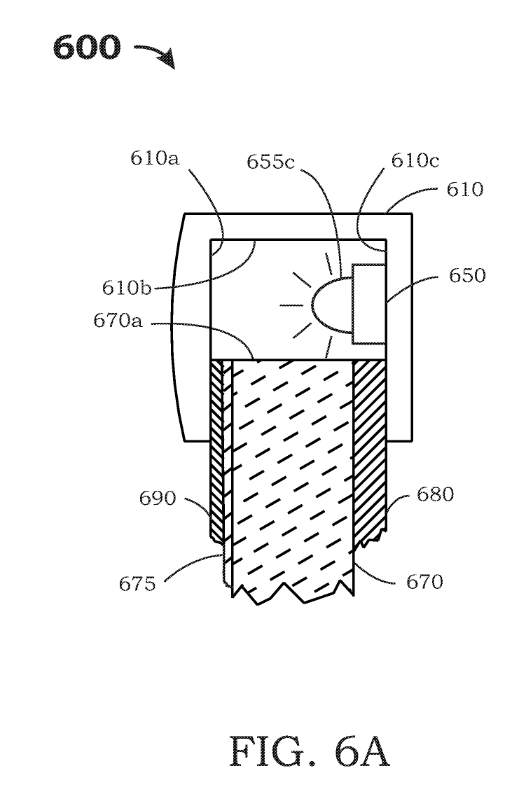

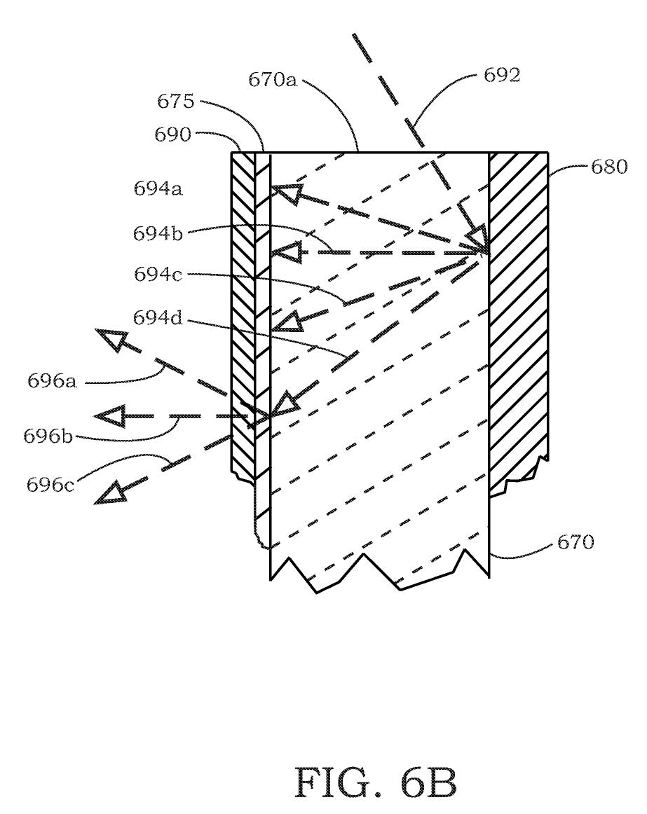

Hence in accordance with another aspect of the invention as illustrated by the cross-sectional views FIGS. 6A and 6B of display panel 600, a dispersion layer 675 is positioned in front of diffusion layer 670. The inclusion of dispersion layer 675 improves the overall light transmission efficiency of panel 600 by increasing the transmission of higher-order light rays from point light source 655c and also from additional point light sources (not shown) inside frame member 610, through diffusion layer 670, dispersion layer 675 and transparency 690. Note that light source 655c can be attached to frame member 610 via any of surfaces 610a, 610b, 610c.

In this embodiment, backscattering layer 680 is approximately several microns to about 3 mm in thickness, and should be opaque, and diffusive with high reflectance, preferably over 90%. Suitable materials for back-scattering layer 680 include aluminum oxide and titanium oxide, any suitable rare earth coating, or a highly reflective diffusive plastic sheet.

Diffusion layer 670 can be about 5 to 10 mm thick and should be as optically transparent as possible. Ideally, diffusion layer 670 should not have scattering materials impregnated since that will cause absorption of the light. In addition, surface 670a of diffusion layer 670 should be roughened in the manner described above in order to minimize the saw-tooth effect.

Dispersion layer 675 can be about 3 to 10 microns with mode optical scattering properties. Layer 675 can be a lower index layer relative to diffusion layer 670. In addition, dispersion layer 675 may have a scattering medium that has a different refractive index impregnated to provide even scattering relative to the total area of panel 600.

Both layers 670 and 675 can be made of a suitable acrylic material, e.g. polymethamethacrylate. In this example, layer 670 has a refractive index N of about 1.47 to 1.49 and layer 675 has a refractive index N of about 1.33 to 1.35.

Referring to both FIGS. 6A and 6B, an exemplary higher-order light ray 692 from light source 655c enters surface 670a and is reflected in a scattered pattern by backscattering layer 680 into rays 694a, 694b, 694c, 694d directed towards dispersion layer 675. Note that reflected ray 694d arrives at steeper angle at dispersion layer 675 than rays 694a, 694b, 694c, and hence ray 694d is further scattered by dispersion layer 675 as rays 696a, 696b and 696c through transparency 690. In this example, although ray 694d is reflected off backscattering layer 680, ray 694d can also depict similarly-angled rays directly generated by light source 655c. Ideally, light transmission at the interface between diffusion layer 670 and dispersion layer 675 should be greater than 90% with minimal Fresnel losses.

Further, in order to minimize variation of light intensity over panel 600, a variable pattern of reflectance can be incorporated into the back surface of layer diffusion layer 670 so that the reflectance increases in a direction away from LED 655c.

The resulting multi-layer sandwich comprising of dispersion layer 675, diffusion layer 670 and backscattering layer 680 can be manufactured using a cast layering process, an enclosed liquid polymerization extrusion process, or a combination thereof, using techniques known to one skilled in the plastics manufacturing arts. Alternatively, backscattering layer 680 be evaporated on, bonded to or attached to the back surface of diffusion layer 670 with a suitable adhesive.

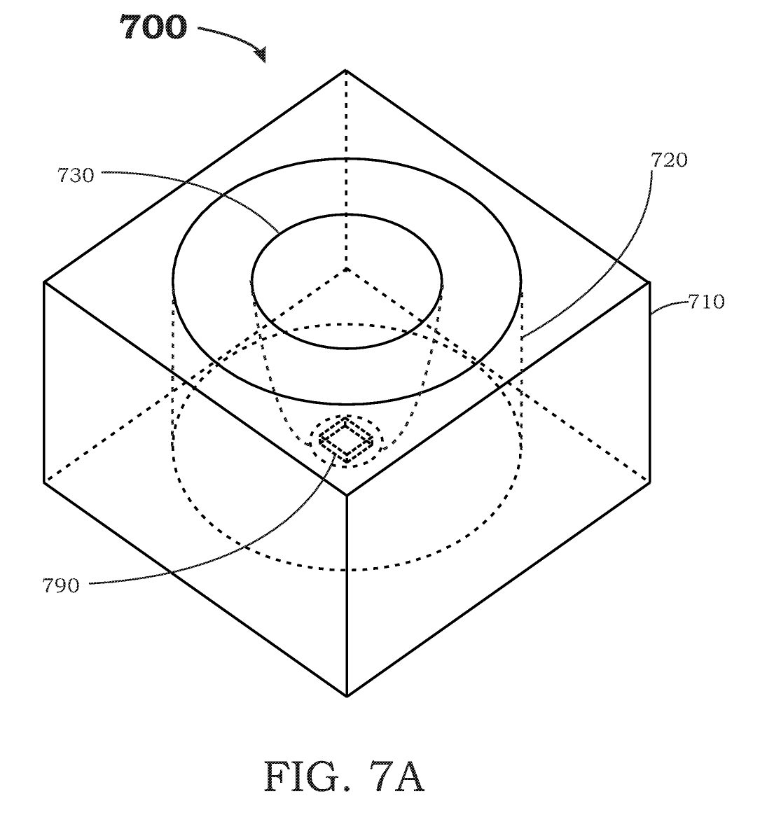

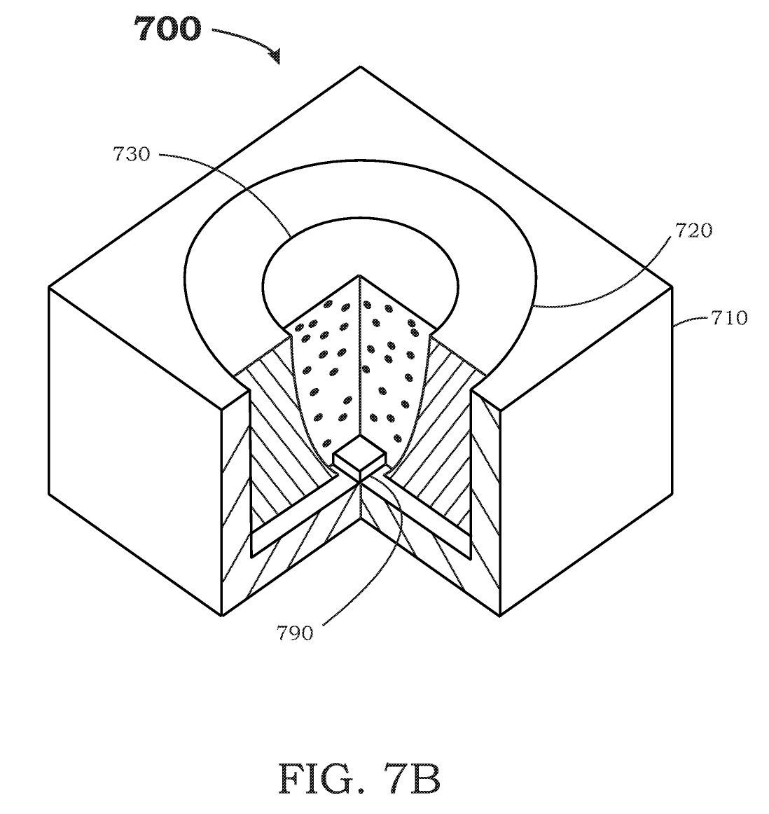

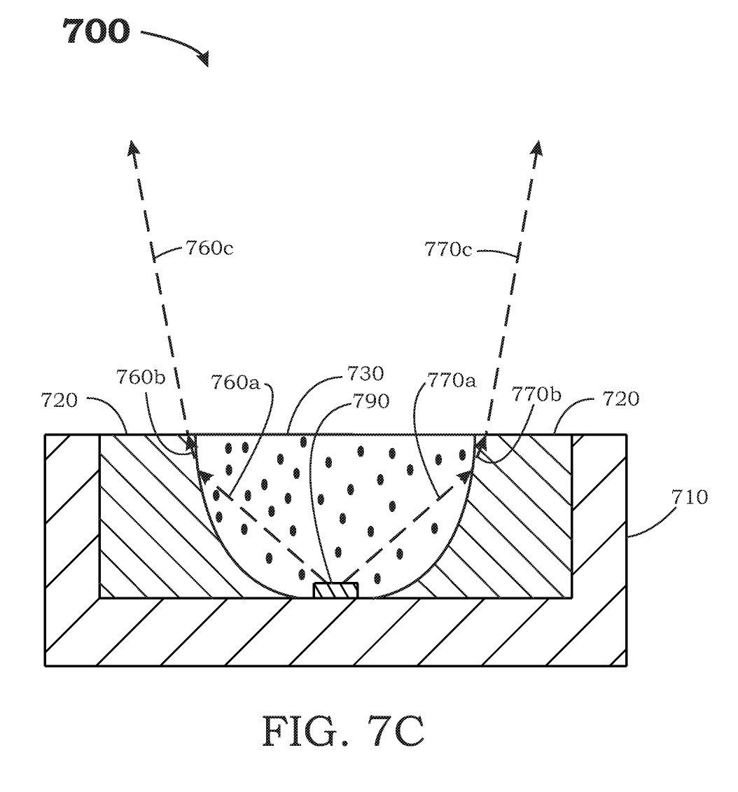

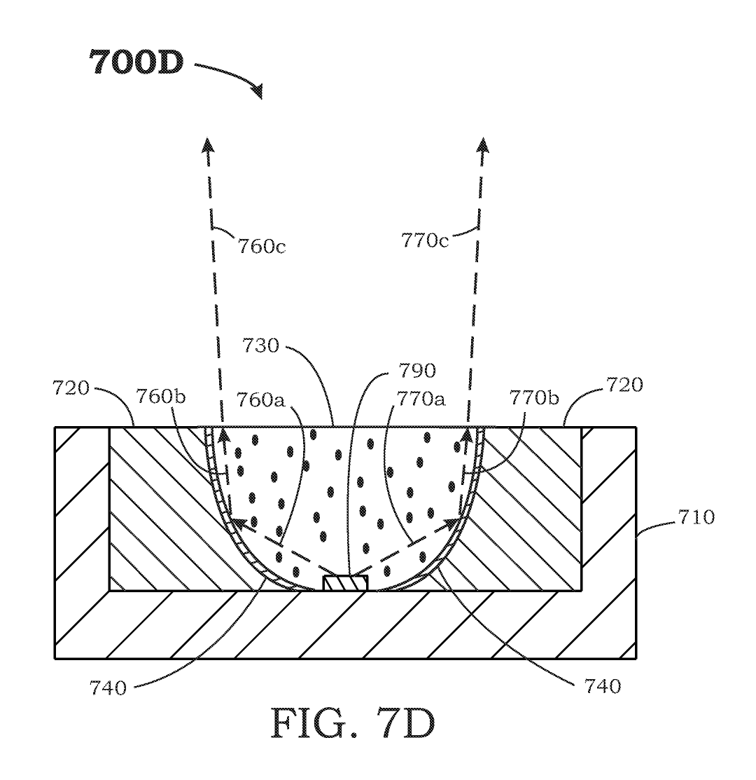

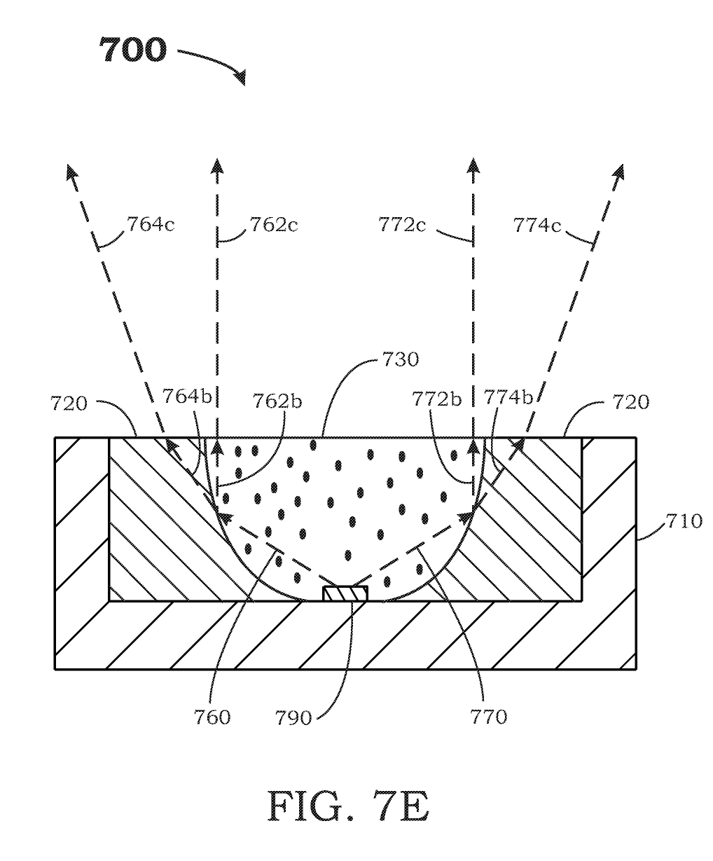

FIGS. 7A, 7B and 7C are an isometric view, a cut-away view and a cross-sectional view, respectively, of a highly efficient LED module 700 in accordance with an aspect of the present invention. LED module 700 includes a base 710, an outer beam director 720, an inner beam director 730, and an LED 790.

Suitable materials for base 710 include high temperature acrylic co-polymer and for beam directors 720, 730 include acrylic and optical grade silicone. Depending on the application, beam directors 720, 730 can be an optically clear material or slightly diffusive. LEDs suited for LED 790 include commercially available LEDs from www.osram-os.com such as model numbers LW-E6SG, LW-G6SP and LW-541C.

Since most efficient LEDs typically generate substantially more blue and ultraviolet light, LED 790 can be geometrically coated with a suitable phosphor layer, also known as conformal phosphor coating (not shown), known to one skilled in the art so as to produce a compact LED capable of generating a whiter light beam whose spectrum is better suited for illuminating display panels. This is possible because an even phosphor coating minimizes chromatic separation of the white light generated by LED 790. It is also possible to use LEDs that generate a whiter light spectrum without an additional phosphor layer.

While LEDs have been used for illumination applications, most commercially available LED packages are designed to generate a fairly wide-angled and evenly-spread beam of light for applications such as area lighting. Hence, these off the shelf LED packages are not suitable for edge illumination of display panels because a wide-angled beam will generate a substantially higher level of illumination closer to the edge of the display panels resulting in uneven illumination.

In contrast, light sources for edge illumination of the display panels should be capable of generating a substantially narrow beam of penetrating light so as to evenly illuminate the central portions of the display panels which can have a large display surface area.

In accordance with one aspect of the present invention as illustrated by FIG. 7C, the deep penetration needs are accomplished primarily by reliance on the refractive and/or reflective properties of the interface between outer beam director 720 and inner beam director 730. The refractive and/or reflective properties can be controlled by selecting suitable interface profiles and N index values. Suitable profiles for beam director interfaces include parabolic and elliptical curved shapes. Suitable N values include for example, N1 being approximately 1.33 to 1.41 and N2 being approximately 1.49 to 1.6 for beam directors 720 and 730, respectively. In some embodiments, most of the light produced by LED module 700 is substantially concentrated within an approximately 40 degree beam angle.

Accordingly, exemplary light rays 760a, 770a produced by LED 790 are refracted by beam directors 720, 730 into rays 760b, 770b, respectively. Light rays 760b, 770b are further refracted by the external surface of outer beam director 720 into rays 760c, 770c, and thereby enabling LED module 700 to generate a substantially narrower beam of light than that initially produced by LED 790.

FIG. 7D shows a modified LED module 700D in which a reflective layer 740 is added between outer beam director 720 and inner beam director 730 thereby enhancing the reflective properties of the interface between beam directors 720, 730. Reflective layer 740 can be formed by techniques well known in the art including vapor and electrostatic deposition. Light rays 760a, 770a produced by LED 790 are reflected by layer 740 into rays 760b, 770b, respectively, enabling LED module 700D to produce a substantially narrow and penetrating beam of light including rays 760c, 770c.

As discussed above, a substantially wide-angled beam will better illuminate the surface of display panels closest to the light source, while a substantially narrow light beam is especially beneficial for deeper penetration of relatively large display panels. At first blush, the shallow penetration and deep penetration needs appear to be competing requirements.

In accordance with another aspect of the present invention as illustrated by the cross-sectional view of FIG. 7E, both shallow and deep penetration needs can be accomplished by reliance on a suitable balance between the reflective and/or refractive properties of the interface between outer beam director 720 and inner beam director 730. This delicate refractive/reflective balance can be controlled by selecting suitable materials with suitable relative N values for directors 720, 730, e.g. N1 being approximately 1.33 to 1.41 and N2 being approximately 1.49 to 1.6, respectively.

For example, light ray 760 is refracted into ray 764b and also reflected as ray 762b, while light ray 770 is reflected into ray 774b and also reflected as ray 772b. Hence LED module 700 is now capable of producing a substantially narrow beam of light, e.g., rays 762c, 772c, for penetrating the display panel while still able to produce enough shorter range light rays, e.g., rays 764c, 774c to illuminate the closer surface of the display panel. As a result, LED module 700 is capable of generating variable intensity ranges at various beam angles, e.g., 80% intensity at between 0 and 40 degrees, and 20% intensity between 40 to 80 degrees.

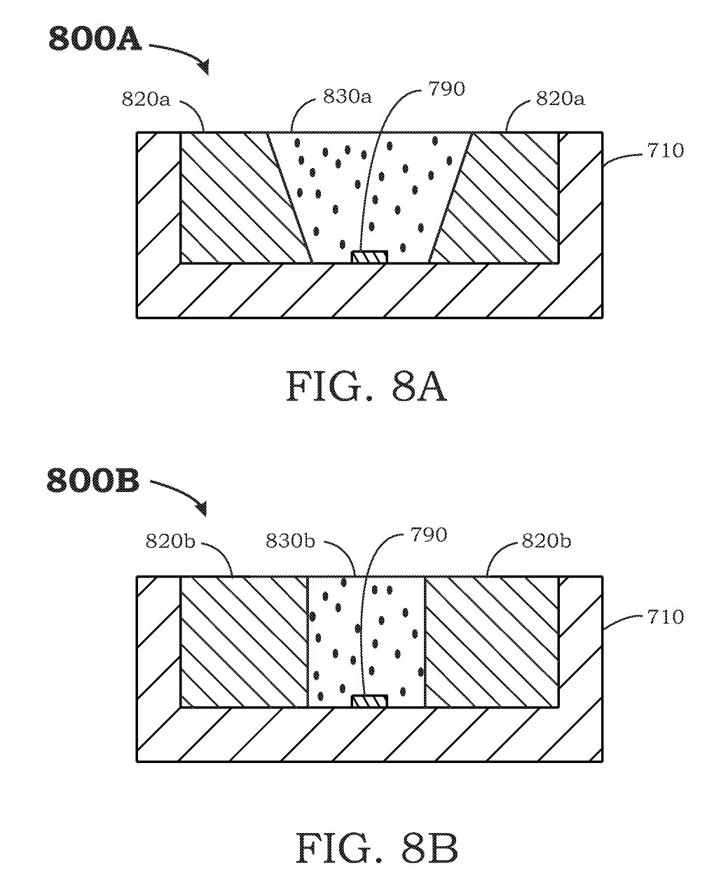

Several additions and modifications to LED module 700 are also possible as shown in the exemplary cross-sectional views of FIGS. 8A through 10E. Many other additions and modifications are also possible within the scope of the present invention.

FIGS. 8A and 8B show embodiments 800A, 800B with substantially straight interface profiles between outer beam directors 820a, 820b and inner beam directors 830a, 830b, respectively. Note the cone-shaped inner beam director 830a and cylindrical-shaped inner beam director 830b.

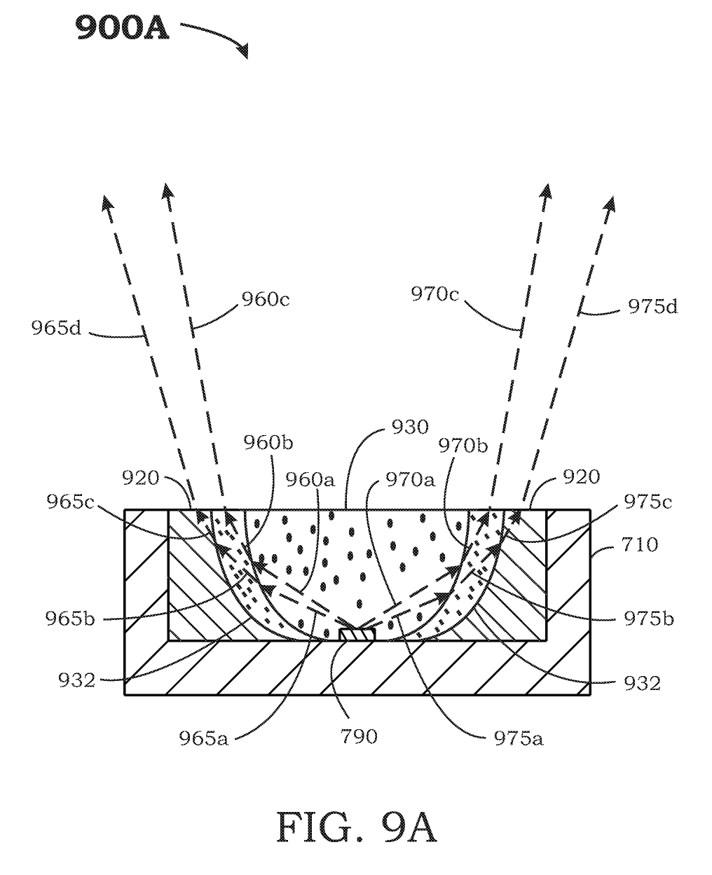

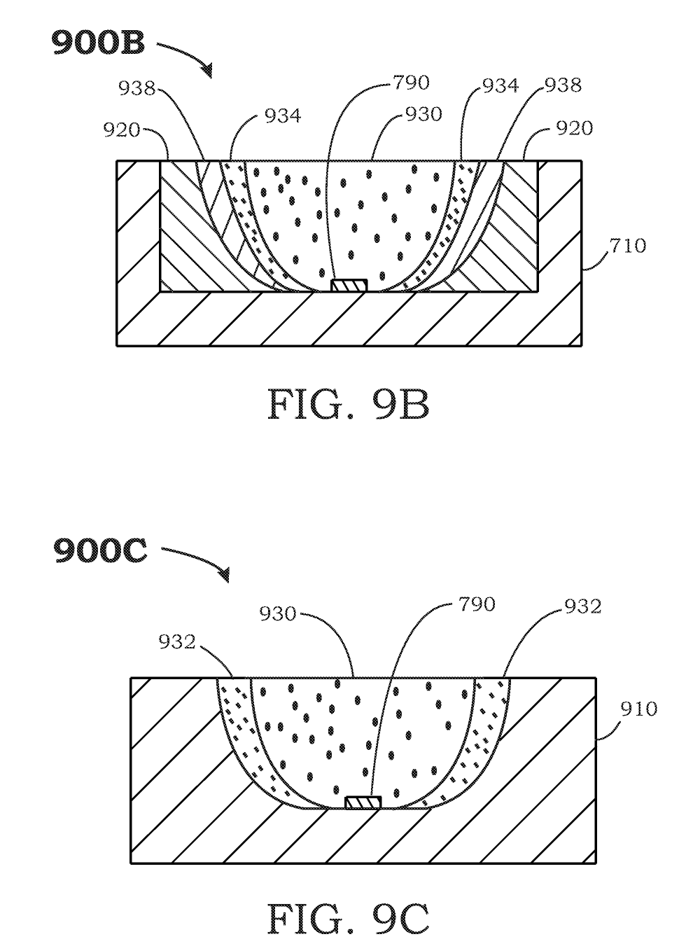

FIGS. 9A-9C illustrate additional embodiments with multiple refractive and/or reflective interfaces introduced by adding intermediate beam directors, i.e., directors 932 of module 900A, directors 934, 938 of module 900B, and director 932 of module 900C. As discussed above, the multiple interfaces can have refractive and/or reflective properties defined by suitable interface profiles and N values.

For example, light rays 960a, 970a produced by LED 790 are refracted by the interface between beam directors 930, 932 into rays 960b, 970b, respectively. Light rays 960b, 970b are further refracted by the external surface of intermediate beam director 932 into rays 960c, 970c.

Similarly, light rays 965a, 975a produced by LED 790 are refracted by the interface between beam directors 932, 930 into rays 965b, 975b, respectively, which are in turn further refracted by the interface between beam directors 920, 932 into rays 965c, 975c. Light rays 965c, 975c are then refracted by the external surface of outer beam director 920 into rays 765d, 775d.

As a result, a focused beam of light including exemplary light rays 965d, 960c, 970c, 975d is formed, enabling LED module 900A to generate a substantially narrower and penetrating beam of light than that initially produced by LED 790. As discussed above, the balance between the refractive and/or reflective properties of beam directors 920, 932, 930 can be controlled by selecting suitable materials with suitable relative N values for directors 920, 932, 930. In addition, beam directors 920, 932, 930 can be optically clear or slightly diffusive.

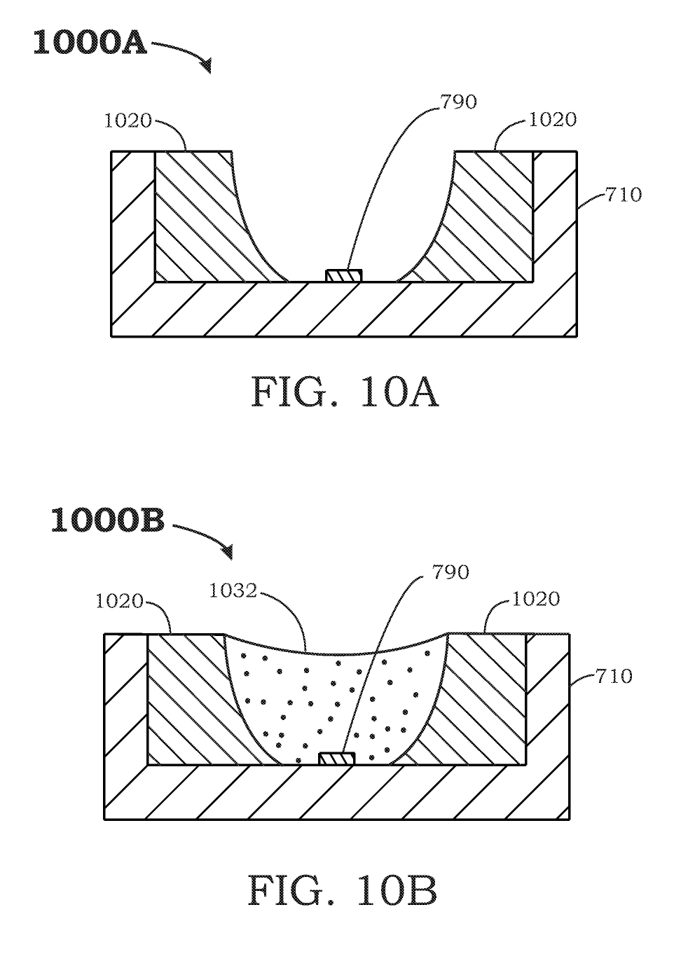

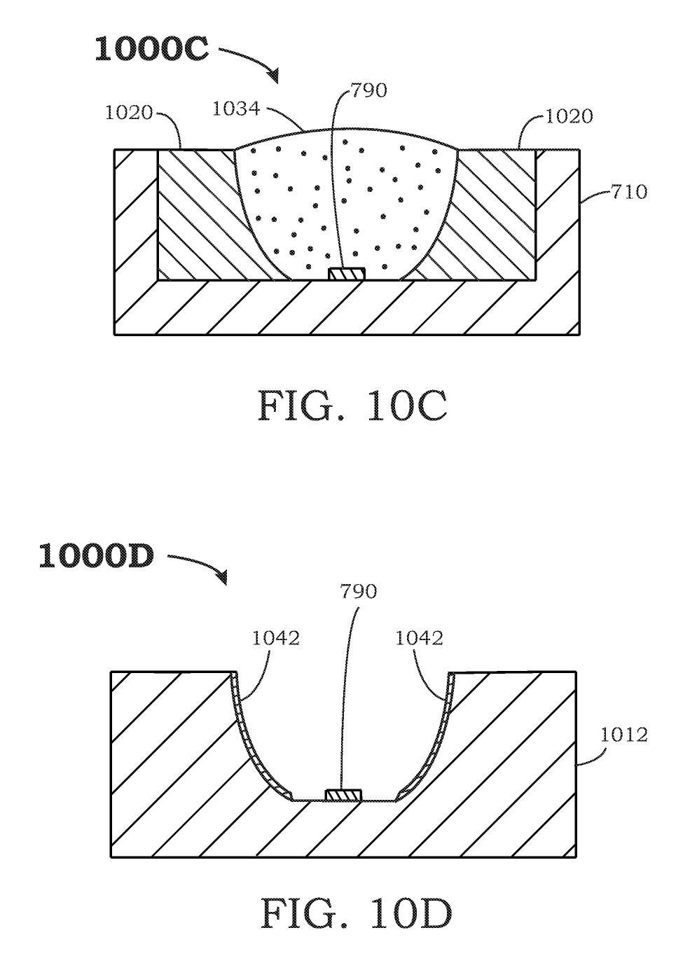

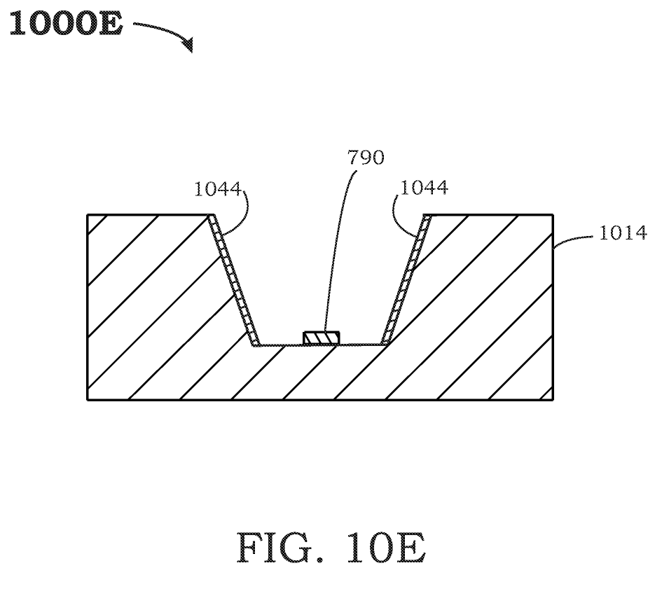

The cross-sectional views of FIGS. 10A-10E show additional possible LED module embodiments, e.g., module 1000A without an inner beam director; module 1000B with a concave-topped inner beam director 1032; module 1000C with a convex-topped inner beam director 1034; module 1000D has an exposed LED 790 and a substantially reflective layer 1042 with a curved profile; and module 1000E has an exposed LED 790 and a substantially reflective layer 1044 with a cone-shaped profile.

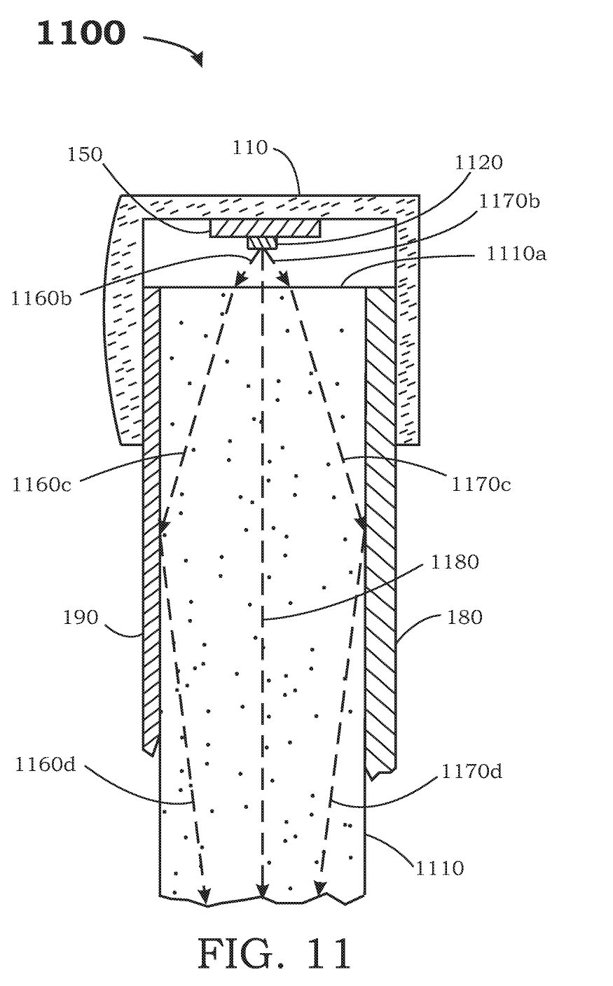

Referring now to FIG. 11 which is a cross-sectional view of the top portion of a display panel 1100 which includes a top frame member 110, an LED module 1120 attached to a light base 150, and an illuminated display comprising a transparency 190, a diffusion layer 1110 and a back-scattering layer 180. Light base 150 provides power to LED module 1120. Light base 150 also functions as a heat-sink for LED module 1120 by dissipating heat from module 1120 to frame member 110.

LED module 1120 can be any one of exemplary LED modules 700, 700D, 800A, 800B, 900A, 900B, 900C, 1000A, 1000B, 1000C, 1000D and 1000E. As discussed above, LED module 1120 generates a substantially narrow beam of light including light rays 1160b, 1180, 1170b, capable of penetrating diffusion layer 1110 thereby ensuring that transparency 190 is evenly illuminated, regardless of the surface area of transparency 190. In other words, the illumination provided by dispersion layer 1110 to transparency 190 should not vary by more than about 20% between the surface of transparency 190 closest to frame member 110 and the center of transparency 190 (not shown).

Depending on the specific application and the size of display panel 1110, edge 1110a of diffusion layer 1110 can be polished, semi-polished or roughened by for example sandblasting, etching, or saw cuts, thereby controlling the diffusion characteristics of edge 1110a, as light rays 1160b, 1170b initially enters layer 1110 and refracts into light rays 1160c, 1170c respectively.

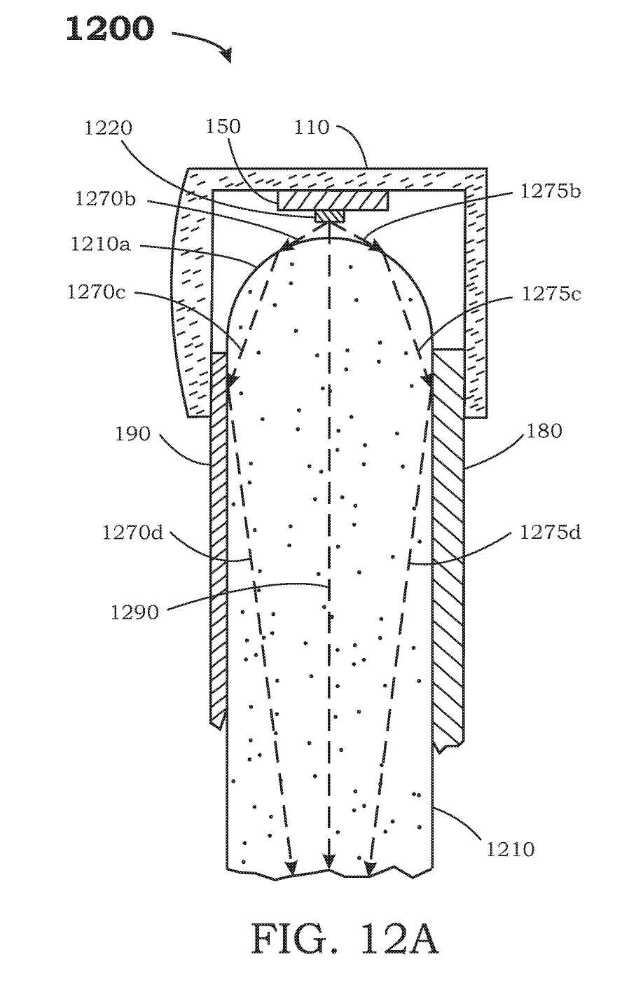

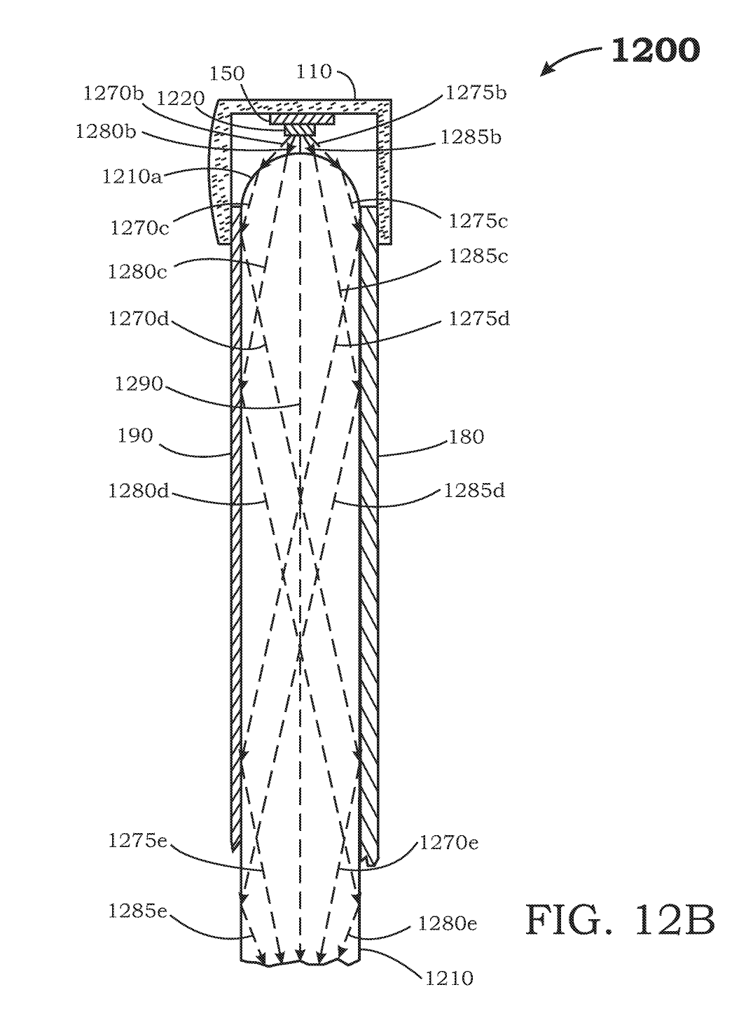

FIGS. 12A, 12B are cross-sectional views illustrating another aspect of the invention, showing the top portion of a display panel 1200 which includes a top frame member 110, a substantially wide-angled LED module 1220 attached to a light base 150, and an illuminated display comprising a transparency 190, a diffusion layer 1210 and a back-scattering layer 180. Light base 150 provides power to and dissipated heat generated by LED module 1220.

In accordance with the present invention, edge profile 1210a of diffusion layer 1210 is optimized for even illumination of display panel 1200 by focusing the substantially wide-angled light beam emitted by LED module 1220 into a substantially narrower beam of light as the light rays from module 1220 refract into diffusion layer 1210, e.g., as light rays 1270b, 1275b refract into light rays 1270c, 1275c. By selecting a suitable N value, e.g., approximately 1.49, for diffusion layer 1210, the convex edge profile 1210a is able to function as an integral convex lens thereby eliminating the need for an external focusing lens between LED module 1220 and diffusion layer 1210.

The convex edge profile 1210a can be formed during the extrusion of the diffusion layer 1210, or by a suitable mechanical or chemical technique such as sanding, grinding, machining, sawing, laser or etching. The curved edge profile 1210a for diffusion layer 1210 can also be formed by localized heat and gravity.

FIG. 12B illustrates in greater detail how the substantially narrower beam of light from LED module 1220 is able to penetrate deeper into diffusion layer 1210. In this example, lights rays 1270c, 1275c, 1280c, 1285c are internally reflected inside diffusion layer 1210 as rays 1270d, 1275d, 1280d, 1285d, and then further reflected as rays 1270e, 1275e, 1280e, 1285e.

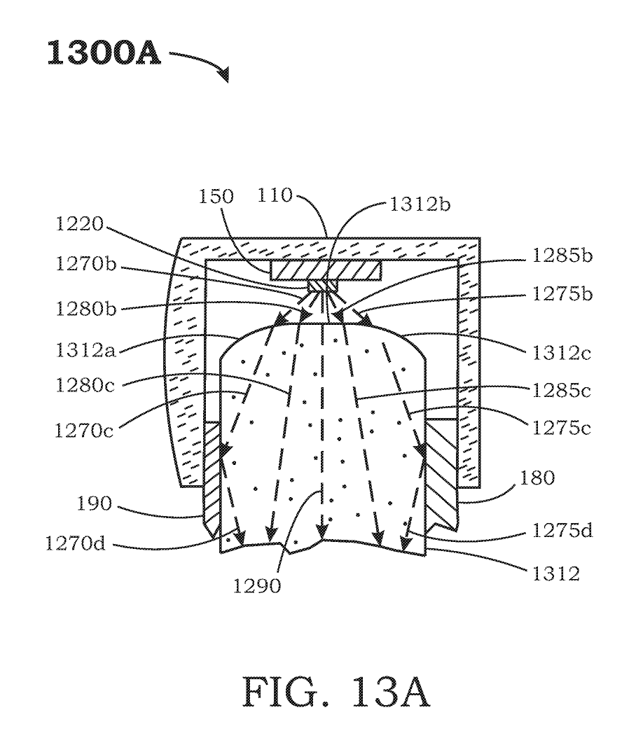

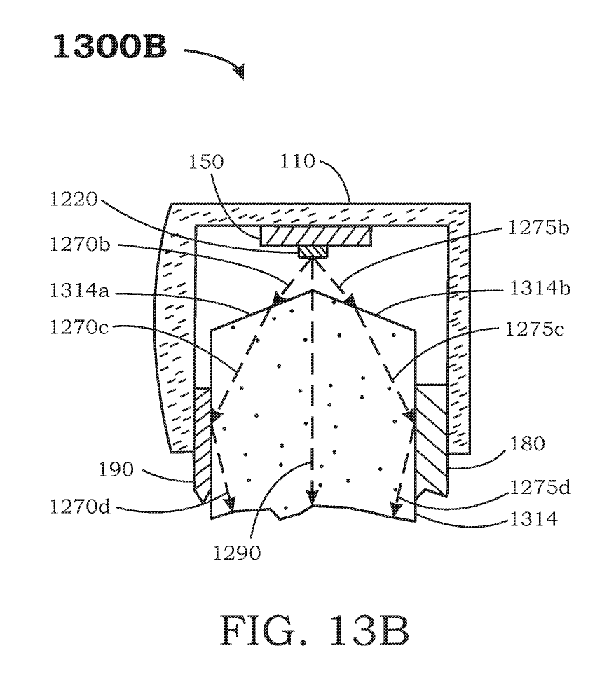

Other edge profiles for diffusion layers are also possible within the scope of the present invention, as illustrated by the cross-sectional views of FIGS. 13A, 13B showing the top portions of display panels 1300A, 1300B.

For example, in FIG. 13A, diffusion layer 1312 of display panel 1300A includes a curved outer portion 1312a which refracts ray 1270b into ray 1270c; a substantially-flat central portion 1312b which refracts rays 1280b, 1285b into 1280c, 1285c, respectively; and a curved outer portion 1312c which refracts rays 1275b into ray 1275c.

In another embodiment as shown in FIG. 13B, diffusion layer 1314 of display panel 1300B includes an inclined substantially-flat portion 1314a which refracts ray 1270b into ray 1270c; and an inclined substantially-flat portion 1312c which refracts rays 1275b into ray 1275c.

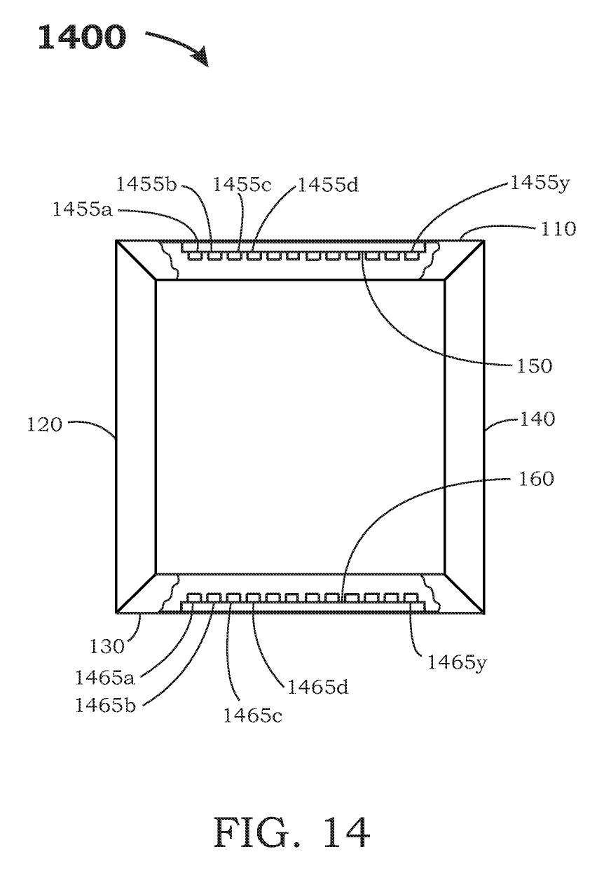

FIG. 14 is a front view showing an embodiment of an illuminated panel 1400 in accordance with the present invention. Panel 1400 includes frame members 110, 120, 130, 140. To facilitate discussion, the front portion of top frame member 110 and the front portion of bottom frame member 130 have cutaways exposing a top row of LED modules 1455a, 1455b, 1455c, 1355d . . . 1455y and a bottom row of LED modules 1465a, 1465b, 1465c, 1465d . . . 1465y, respectively.

Panel 1400 can include feature(s) from one or more of panels 1100, 1200, 1300A and 1300B. LED modules 1455a, 1455b, 1455c, 1355d . . . 1455y, and modules 1465a, 1465b, 1465c, 1465d . . . 1465y can include feature(s) from one or more of exemplary LED modules 700, 700D, 800A, 800B, 900A, 900B, 900C, 1000A, 1000B, 1000C, 1000D, 1000E, and 1220.

In this example, LED modules 1455a, 1455b, 1455c, 1355d . . . 1455y, and 1465a, 1465b, 1465c, 1465d . . . 1465y are spaced approximately 5-10 mm center to center or approximately 30 to 40 LED modules per linear foot. LED 790 can be Osram LW-E6SG generating about 4000 lumens each. Accordingly, LED modules 1455a, 1455b, 1455c, 1355d . . . 1455y, and 1465a, 1465b, 1465c, 1465d . . . 1465y generate about 145,000 luminous flux per linear foot.

It is also possible to combine LED modules with different beam angles. For example, instead of every LED modules 1455a, 1455b, 1455c, 1355d . . . 1455y having a beam angle of substantially 40 degrees, LED modules 1455a, 1455c, 1465a, 1465c may have a beam angle of substantially 40 degrees, while LED modules 1455b, 1455d, 1465b, 1465d may have a beam angle of substantially 80 degrees.

Besides illuminated panels, the LED modules of the present invention described above can also be used for other applications such as architectural lighting requiring focused beams of light. Such LED modules with controlled focus will eliminate the need for external reflectors, resulting in a functional as well as an aesthetically pleasing, compact and streamed-lined point light sources.

Many modifications and variations are possible. For example, panels 100, 200, 300 . . . 1400 can be dimmable by adding a variable current control circuitry. An infrared red sensor can also be added to the control circuitry of panels 100, 200, 300 . . . 1400 so that the panels are triggered when a potential customer enters the detection field thereby dimming or turning on and off in an appropriate manner.

In some applications, in addition to the edge lights described in the above embodiments, panels 100, 200, 300 . . . 1400 can also be back-lighted by additional light sources (not shown). Accordingly, dispersion layers and/or backscattering layers, e.g., layers 670, 680, can be opaque in order to diffuse the back lighting.

Further, since white LEDs are not the most efficient emitter of light, it is also possible for LED 655c to transmit light in the substantially blue-to-ultraviolet range into diffusion layer 670, to include phosphors in dispersion layer 675 or back-scattering layer 680 or combinations thereof, and to convert the blue-to-ultraviolet light into white light or any colored light within the visible spectrum.

Other modifications and variations are also possible. For example, it is also possible to sense the ambient light level of the surrounding and adjust the light output of the panels accordingly, thereby conserving power. The present invention can also improve the quality and quantity of light transmitted by other non-point light sources such as neon and fluorescent light sources.

In the above described embodiments, frame members of panels 100, 200, 300 . . . 1400 can be manufactured from aluminum extrusions. The use of any other suitable rigid framing materials including other metals, alloys, plastics and composites such as steel, bronze, wood, polycarbonate, carbon-fiber, and fiberglass is also possible.

In sum, the present invention provides an improved illuminator using light sources such as LEDs for evenly illuminating panels that is easy to manufacturer, easy to maintain, shock resistant, impact resistant, portable, cost effective, and have long lamp-life, while minimizing the “saw-tooth” effect in the emitted light pattern.

While the present invention has been described with reference to particular embodiments, it will be understood that the embodiments are illustrative and that the inventive scope is not so limited. In addition, the various features of the present invention can be practiced alone or in combination. Alternative embodiments of the present invention will also become apparent to those having ordinary skill in the art to which the present invention pertains. Such alternate embodiments are considered to be encompassed within the spirit and scope of the present invention. Accordingly, the scope of the present invention is described by the appended claims and is supported by the foregoing description.

What is claimed is:

1. A light emitting diode (LED) module useful in association with an edge-illuminated panel, the LED module comprising:
a base;
an LED located substantially within the base and configured to generate a light beam;
an inner beam director; and
an outer beam director, wherein an interface between the inner beam director and the outer beam director is shaped to refract and reflect the light beam along the interface, thereby narrowing a substantial portion of the light beam.

2. The LED module of claim 1 wherein the LED has a geometrically coated phosphor layer.

3. The LED module of claim 1 wherein the interface between the inner beam director and the outer beam director includes an intermediate beam director configured to further refract and reflect the light beam generated by the LED.

4. The LED module of claim 1 wherein the shaped interface is curved.

5. The LED module of claim 4 wherein the shaped interface is parabolic.

6. The LED module of claim 4 wherein the shaped interface is elliptical.

7. The LED module of claim 1 wherein the shaped interface is highly reflective.

8. The LED module of claim 3 wherein the intermediate beam director is highly reflective.

9. The LED module of claim 1 wherein the inner beam director has a first N value and the outer beam director has a second N value, and wherein the first N value is substantially lower than the second N value.

10. The LED module of claim 9 wherein the first N value is approximately 1.33 to 1.45 and wherein the second N value is approximately 1.49 to 1.6.

11. An edge-illuminated panel comprising:
a panel frame having at least one illuminated frame member;
a diffusion layer coupled to the at least one illuminated frame member; and
at least one row of light emitting diode (LED) modules located substantially within the at least one illuminated frame member, wherein the LED modules are configured to edge-illuminate the diffusion layer, and wherein at least one of the LED modules includes:
a base;
an LED located substantially within the base and configured to generate a light beam;
an inner beam director; and
an outer beam director, wherein an interface between the inner beam director and the outer beam director is shaped to refract and reflect the light beam along the interface, thereby narrowing a substantial portion of the light beam.

12. The edge-illuminated panel of claim 11 wherein the LED has a geometrically coated phosphor layer.

13. The edge-illuminated panel of claim 11 wherein the interface between the inner beam director and the outer beam director includes an intermediate beam director configured to further refract and reflect the light beam generated by the LED.

14. The edge-illuminated panel of claim 11 wherein the shaped interface is curved.

15. The edge-illuminated panel of claim 14 wherein the shaped interface is parabolic.

16. The edge-illuminated panel of claim 14 wherein the shaped interface is elliptical.

17. The edge-illuminated panel of claim 11 wherein the shaped interface is highly reflective.

18. The edge-illuminated panel of claim 13 wherein the intermediate beam director is highly reflective.

19. The edge-illuminated panel of claim 11 wherein the inner beam director has a first N value and the outer beam director has a second N value, and wherein the first N value is substantially lower than the second N value.

20. The edge-illuminated panel of claim 19 wherein the first N value is approximately 1.33 to 1.45 and wherein the second N value is approximately 1.49 to 1.6.

21. The edge-illuminated panel of claim 11, and wherein the LED modules further includes a second LED module which is configured to generate a substantially wider light beam than the light beam generated by the at least one LED module.

22. The edge-illuminated panel of claim 11 wherein the light beam generated by the at least one LED module is substantially narrowed to approximately 40 degrees or less, and wherein the LED modules further includes a second LED module which is configured to generate a substantially wider light beam of approximately 80 degrees or more.
